(19) United States
(12) Patent Application Publication
(10) Pub. No.: US 2026/0062546 A1
(43) Pub. Date: Mar. 5, 2026

(54) Thermoplastic Resin Composition and Molded Product Manufactured from Same

(71) Applicant: LOTTE CHEMICAL CORPORATION, Seoul (KR)

(72) Inventors: In-Chol KIM, Uiwang-si (KR); Hyeongseob SHIN, Uiwang-si (KR); Donghui CHU, Uiwang-si (KR); Jungwook KIM, Uiwang-si (KR); Jieun PARK, Uiwang-si (KR)

(21) Appl. No.: 19/105,142

(22) PCT Filed: Aug. 23, 2023
(86) PCT No.: PCT/KR2023/012486

§ 371 Date: Feb. 20, 2025

(30) Foreign Application Priority Data
Aug. 31, 2022 (KR) 10-2022-0110102

(51) Int. Cl. C08L 33/12; C08K 5/08; C08K 5/134

(52) U.S. Cl. CPC C08L 33/12; C08K 5/08; C08K 5/134; C08L 2201/02; C08L 2207/53

(57) ABSTRACT

Provided is a thermoplastic resin composition including, based on 100 parts by weight of a base resin including (A) 15 to 25 wt % of an acrylate-based rubber-modified graft copolymer, and (B) 75 to 85 wt % of a polymethyl methacrylate resin including 0.5 to 3 wt % of a methyl acrylate-derived component, (C) 0.1 to 1 part by weight of an anthraquinone-based dye; and (D) 0.1 to 0.5 parts by weight of a multifunctional radical scavenger.

### TECHNICAL FIELD

The present invention relates to a thermoplastic resin composition and a molded product manufactured therefrom.

### BACKGROUND ART

Recently, in line with eco-friendly trends and demands for cost reduction, an unpainted thermoplastic resin capable of being used without a painting process is increasingly being demanded. Since an unpainted molded product made from the unpainted thermoplastic resin is used without further painting, the unpainted thermoplastic resin should have excellent scratch resistance, colorability, impact resistance, weather resistance, and the like.

Accordingly, as the unpainted thermoplastic resin, an acrylonitrile-styrene-acrylate copolymer resin (hereinafter, ASA resin) having overall excellent impact resistance, heat resistance, weather resistance, and the like has been used but exhibits somewhat inferior physical properties such as heat resistance and the like, colorability, appearance characteristics, and the like to a general thermoplastic resin used for a painted molded product and thus is limitedly being used.

In particular, vehicle exterior parts and the like are exposed to an external environment and mostly require excellent heat resistance (e.g., Vicat softening temperature (VST) of greater than or equal to 100° C.), but the unpainted thermoplastic resin has low heat resistance and thus may not satisfy this requirement.

In order to solve this problem, there has been an attempt to improve the heat resistance by blending a polymer with excellent heat resistance polymer (e.g., an α-methylstyrene-based copolymer) with the unpainted thermoplastic resin, but there is another problem of reducing transparency and colorability and deteriorating appearance characteristics due to a refractive index difference between continuous phase (matrix) and dispersed phase (domain).

Accordingly, there is a need for research on a thermoplastic resin composition having excellent colorability, weather resistance, and appearance characteristics as well as excellent heat resistance.

### DISCLOSURE

### Technical Problem

An embodiment provides a thermoplastic resin composition having excellent heat resistance, colorability, weather resistance, and appearance characteristics and a molded product manufactured therefrom.

### Technical Solution

According to an embodiment, a thermoplastic resin composition includes: based on 100 parts by weight of a base resin including (A) 15 to 25 wt % of an acrylate-based rubber-modified graft copolymer; and (B) 75 to 85 wt % of a polymethyl methacrylate resin including 0.5 to 3 wt % of a methyl acrylate-derived component; (C) 0.1 to 1 part by weight of an anthraquinone-based dye; and (D) 0.1 to 0.5 parts by weight of a multifunctional radical scavenger.

The (A) acrylate-based rubber-modified graft copolymer may include a core including an acrylate-based rubbery polymer and a shell formed by graft polymerization of at least one selected from a (meth)acrylate-based compound, an aromatic vinyl compound, and a vinyl cyanide compound onto the core.

An average particle diameter of the acrylate-based rubbery polymer may be 100 to 250 nm.

The (A) acrylate-based rubber-modified graft copolymer may include a butyl acrylate-styrene crosslinked copolymer core and a shell formed by grafting a styrene-acrylonitrile copolymer onto the core.

The (A) acrylate-based rubber-modified graft copolymer may include a butyl acrylate-silicone crosslinked copolymer core and a shell formed by grafting a styrene-acrylonitrile copolymer onto the core.

The (A) acrylate-based rubber-modified graft copolymer may include a butyl acrylate-styrene crosslinked copolymer core and a shell formed by grafting polymethyl methacrylate onto the core.

The (B) polymethyl methacrylate resin including 0.5 to 3 wt % of the methyl acrylate-derived component may include 1 to 2 wt % of the methyl acrylate-derived component.

The (D) multifunctional radical scavenger may include a structure represented by Chemical Formula 1:

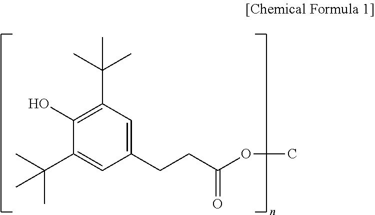

### (in Chemical Formula 1, n is an Integer of 2 to 4)

The thermoplastic resin composition may further include at least one additive selected from a flame retardant, a nucleating agent, a coupling agent, a filler, a plasticizer, an impact modifier, a lubricant, a release agent, a heat stabilizer, an antioxidant, an ultraviolet stabilizer, a pigment, and a dye. In another embodiment, a molded product manufactured from the thermoplastic resin composition is provided.

The molded product may have a brightness (L*) of less than or equal to 1.0, as measured in specular component excluded mode according to ASTM E308 on a 2.5 mm-thick specimen.

The molded product may have a Vicat softening temperature (VST) of greater than or equal to 100° C. as measured under B50 conditions according to ISO 306 standard.

The molded product may have a color change (ΔE) of less than or equal to 2.0 before and after a weathering test measured by irradiating the molded product with 4,500 kJ of energy according to the SAE J 1960 standard.

The molded product may have a volatile gas generation amount of less than or equal to 600 ppm, as measured through a weight increase of the glass plate by placing 4 g of the molded product in a glass petri dish with a diameter of 5 cm, covering the top with a glass plate, heating it on a hot plate at 250° C. for 2 hours, and then cooling the plate temperature to room temperature.

### Advantageous Effects

A thermoplastic resin composition having excellent heat resistance, colorability, weather resistance, and appearance characteristics, and a molded product manufactured therefrom may be provided.

### MODE FOR INVENTION

Hereinafter, embodiments of the present invention are described in detail. However, these embodiments are exemplary, and this disclosure is not limited thereto.

In the present specification, unless otherwise mentioned, “copolymerization” refers to a block copolymerization, a random copolymerization, or a graft-copolymerization and “copolymer” refers to a block copolymer, a random copolymer, or a graft copolymer.

In the present specification, unless otherwise mentioned, the average particle diameter of the rubbery polymer refers to a volume average diameter, and means a Z-average particle diameter measured using a dynamic light scattering analysis equipment.

In the present specification, unless otherwise mentioned, the weight average molecular weight is measured by dissolving a powder sample in an appropriate solvent and then performing gel permeation chromatography (GPC) with a 1200 series made by Agilent Technologies Inc. (a standard sample is polystyrene made by Shodex).

A thermoplastic resin composition according to an embodiment includes, based on 100 parts by weight of a base resin including (A) 15 to 25 wt % of an acrylate-based rubber-modified graft copolymer; and (B) 75 to 85 wt % of a polymethyl methacrylate resin including 0.5 to 3 wt % of a methyl acrylate-derived component, (C) 0.1 to 1 part by weight of an anthraquinone-based dye; and (D) 0.1 to 0.5 parts by weight of a multifunctional radical scavenger.

Hereinafter, each component of the thermoplastic resin composition is described in detail.

### (A) Acrylate-Based Rubber-Modified Graft Copolymer

A thermoplastic resin composition according to an embodiment includes (A) an acrylate-based rubber-modified graft copolymer. The (A) acrylate-based rubber-modified graft copolymer performs a function of reinforcing various properties of the thermoplastic resin composition, such as impact resistance, mechanical properties, and appearance characteristics.

In an embodiment, the (A) acrylate-based rubber-modified graft copolymer may include a core including an acrylate-based rubbery polymer and a shell formed by graft polymerization of at least one selected from a (meth)acrylate-based compound, an aromatic vinyl compound, and a vinyl cyanide compound onto the core.

The (A) acrylate-based rubber-modified graft copolymer may be prepared by any preparation method known to those skilled in the art.

The preparation method may be a conventional polymerization method, for example, emulsion polymerization, suspension polymerization, solution polymerization, bulk polymerization, or the like. As a non-limiting example, it may be prepared by preparing an acrylate-based rubbery polymer, and graft polymerizing at least one selected from a (meth)acrylate-based compound, an aromatic vinyl compound, and a vinyl cyanide compound onto a core formed of at least one layer of the acrylate-based rubbery polymer to form a shell of at least one layer.

The acrylate-based rubbery polymer may have an average particle diameter of 100 to 200 nm, or for example 120 to 180 nm. The acrylate-based compound may be for example ethyl acrylate, butyl acrylate, 2-ethyl hexyl acrylate, hexyl acrylate, or a combination thereof.

The acrylate-based monomer may be copolymerized with one or more radically polymerizable other monomers. When copolymerized, an amount of the one or more other radically polymerizable monomer may be 5 to 30 wt %, or for example 10 to 20 wt % based on a total weight of the acrylate-based rubbery polymer.

An average particle diameter of the acrylate-based rubbery polymer may be 100 to 250 nm, for example 100 to 200 nm, for example 100 to 150 nm. Within the above average particle size range, the thermoplastic resin composition may have excellent impact resistance, mechanical properties, and colorability.

In an embodiment, the (meth)acrylate-based compound included in the shell may be at least one selected from methacrylate, acrylate, methyl methacrylate, methyl acrylate, ethyl methacrylate, ethyl acrylate, propyl methacrylate, propyl acrylate, butyl methacrylate, and butyl acrylate, but is not limited thereto.

The aromatic vinyl compound included in the shell may be at least one selected from styrene, α-methylstyrene, p-methylstyrene, p-t-butylstyrene, 2,4-dimethylstyrene, chlorostyrene, vinyltoluene, or vinylnaphthalene, but is not limited thereto.

The vinyl cyanide compound included in the shell may be at least one selected from acrylonitrile, methacrylonitrile, and fumaronitrile, but is not limited thereto.

In an embodiment, when a monomer mixture including the aromatic vinyl compound and the vinyl cyanide compound is graft-polymerized onto a core including the acrylate-based rubbery polymer to form a shell, the shell may be a copolymer of a monomer mixture including the aromatic vinyl compound and the vinyl cyanide compound in a weight ratio of 1:1 to 4:1, for example, 1:1 to 3:1.

In an embodiment, the (A) acrylate-based rubber-modified graft copolymer may include a butyl acrylate-styrene crosslinked copolymer core and a shell formed by grafting a styrene-acrylonitrile copolymer (SAN) onto the core.

In an embodiment, the (A) acrylate-based rubber-modified graft copolymer may include a butyl acrylate-styrene crosslinked copolymer core and a shell formed by grafting polymethyl methacrylate (PMMA) onto the core.

In an embodiment, the (A) acrylate-based rubber-modified graft copolymer may include a butyl acrylate-silicone crosslinked copolymer core and a shell formed by grafting a styrene-acrylonitrile copolymer (SAN) onto the core.

In an embodiment, the (A) acrylate-based rubber-modified graft copolymer may be included in an amount of 15 to 25 wt %, for example, 15 to 20 wt %, for example, 20 to 25 wt %, based on 100 wt % of the base resin. The impact resistance and colorability of the thermoplastic resin composition can be excellent within the above weight percent range.

### (B) Polymethyl Methacrylate Resin Including 0.5 to 3 wt % of Methyl Acrylate-Derived Component

The thermoplastic resin composition according to an embodiment includes (B) a polymethyl methacrylate (PMMA) resin including 0.5 to 3 wt % of a methyl acrylate-derived component, wherein the (B) polymethyl methacrylate resin may impart colorability and weather resistance to the thermoplastic resin composition.

The (B) polymethyl methacrylate resin including 0.5 to 3 wt % of the (B) methyl acrylate-derived component may be obtained by polymerizing a monomer mixture including methyl methacrylate and methyl acrylate by a known polymerization method such as suspension polymerization, bulk polymerization, or emulsion polymerization.

The thermoplastic resin composition of the present invention may secure excellent heat resistance by including the polymethyl methacrylate resin including 0.5 to 3 wt % of the methyl acrylate-derived component. The methyl acrylate-derived component may be included in an amount of greater than or equal to 0.5 wt %, greater than or equal to 1 wt %, greater than or equal to 1.5 wt %, greater than or equal to 2 wt %, or greater than or equal to 2.5 wt %, and less than or equal to 3 wt %, less than or equal to 2.5 wt %, less than or equal to 2.0 wt %, less than or equal to 1.5 wt %, or less than or equal to 1.0 wt %, and specifically may be included in an amount of 1 to 2 wt %. Within the above weight range, the heat resistance of the thermoplastic resin composition may be further improved.

A glass transition temperature of the (B) polymethyl methacrylate resin including 0.5 to 3 wt % of the methyl acrylate-derived component may be 100 to 150° C., for example, 110 to 130° C.

A weight average molecular weight of the (B) polymethyl methacrylate resin including 0.5 to 3 wt % of the methyl acrylate-derived component may be 50,000 to 200,000 g/mol, for example, 70,000 to 150,000 g/mol. Within the above range, the scratch resistance and processability of the thermoplastic resin composition may be improved.

The (B) polymethyl methacrylate resin including 0.5 to 3 wt % of the methyl acrylate-derived component may be included in an amount of 75 to 85 wt %, for example, 75 to 80 wt %, for example, 80 to 85 wt %, based on 100 wt % of the base resin. Within the above weight % range, the thermoplastic resin composition may have excellent colorability, heat resistance, and weather resistance.

### (C) Anthraquinone-Based Dye

The thermoplastic resin composition according to an embodiment may include (C) an anthraquinone-based dye, and the (C) anthraquinone-based dye may cause the thermoplastic resin composition to exhibit a black color. The (C) anthraquinone-based dye may be a compound including greater than or equal to 50 wt % of a component having a structure represented by Chemical Formula 2.

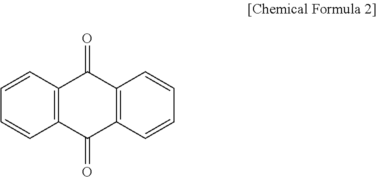 [SMILES: O=C1c2ccccc2C(=O)c2ccccc21]

In an embodiment, a dispersant may be used together with the anthraquinone-based dye to disperse it in the thermoplastic resin composition. Specifically, the dye may be used by previously surface-treating it with the dispersant, or the dispersant may be added together with the dye during the preparation of the thermoplastic resin composition.

The dispersant may be a nonionic dispersant, an anionic dispersant, a cationic dispersant, and the like.

The (C) anthraquinone-based dye may be included in an amount of 0.1 to 1 part by weight, for example, 0.1 to 0.8 parts by weight based on 100 parts by weight of the base resin.

### (D) Multifunctional Radical Scavenger

The thermoplastic resin composition according to an embodiment may include (D) a multifunctional radical scavenger, and the (D) multifunctional radical scavenger may further improve the appearance characteristics of the thermoplastic resin composition of the present invention.

When the polymethyl methacrylate resin including the methyl acrylate-derived component in a relatively low content of 0.5 to 3 wt % as described above is included in the thermoplastic resin composition, there is a problem that sticky decomposition gas is generated when manufacturing a molded product by a method such as injection molding using the thermoplastic resin composition, resulting in a deterioration in the appearance characteristics of the molded product.

In order to solve this problem, the present invention includes a small amount of the multifunctional radical scavenger capable of capturing a large number of radicals in a thermoplastic resin composition, thereby improving the appearance characteristics without deteriorating physical properties such as impact resistance and heat resistance.

The (D) multifunctional radical scavenger may include a structure represented by Chemical Formula 1:

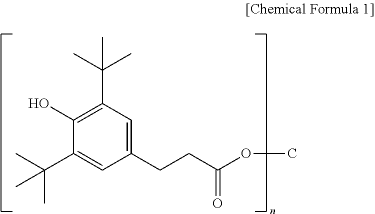

### (in Chemical Formula 1, n is an Integer of 2 to 4)

The (D) multifunctional radical scavenger may be included in an amount of 0.1 to 0.5 parts by weight, for example, 0.1 to 0.3 parts by weight, for example, 0.3 to 0.5 parts by weight, based on 100 parts by weight of the base resin, and within the above range of parts by weight, the appearance characteristics of a molded product manufactured from the thermoplastic resin composition including the same may be further improved.

### (E) Additives

The thermoplastic resin composition according to an embodiment may further include, in addition to the components (A) to (D), one or more additives necessary to balance the properties without causing a deterioration of other properties, or depending on the final use of the thermoplastic resin composition.

Specifically, the additive may further include at least one additive selected from a flame retardant, a nucleating agent, a coupling agent, a filler, a plasticizer, an impact modifier, a lubricant, a release agent, a heat stabilizer, an antioxidant, an ultraviolet stabilizer, a dye, and a pigment.

These additives may be appropriately included within a range that does not impair the properties of the thermoplastic resin composition, and specifically, may be included in an amount of less than or equal to 20 parts by weight based on 100 parts by weight of the base resin, but is not limited thereto.

Meanwhile, the thermoplastic resin composition according to an embodiment can also be mixed and used together with other resins or other rubber components.

Meanwhile, another embodiment provides a molded product manufactured using the thermoplastic resin composition according to an embodiment. The molded product may be manufactured using various methods known in the art, such as injection molding or extrusion molding, using the thermoplastic resin composition.

The molded product may have a brightness (L*) of less than or equal to 1.0, or less than or equal to 0.9 as measured in specular component excluded (SCE) mode according to ASTM E308 on a 2.5 mm-thick specimen.

The molded product may have a Vicat softening temperature (VST) of greater than or equal to 100° C., greater than or equal to 101° C., greater than or equal to 102° C., or greater than or equal to 103° C., as measured under B50 conditions according to ISO 306 standard.

The molded product may have a color change (ΔE) of less than or equal to 2.0, less than or equal to 1.9, less than or equal to 1.8, less than or equal to 1.7, less than or equal to 1.6, less than or equal to 1.5, less than or equal to 1.4, less than or equal to 1.3, less than or equal to 1.2, less than or equal to 1.1, or less than or equal to 1.0 before and after a weathering test measured by irradiating the molded product with 4,500 kJ of energy according to the SAE J 1960 standard.

The molded product may have a volatile gas generation amount of less than or equal to 600 ppm, less than or equal to 550 ppm, or less than or equal to 500 ppm, as measured through a weight increase of the glass plate by placing 4 g of the molded product in a glass petri dish with a diameter of 5 cm, covering the top with a glass plate, heating it on a hot plate at 250° C. for 2 hours, and then cooling the plate temperature to room temperature.

Hereinafter, preferred examples of the present invention will be described. These examples, however, are not in any sense to be interpreted as limiting the scope of the invention.

### Examples 1 to 3 and Comparative Examples 1 to 6

Each thermoplastic resin composition of Examples 1 to 3 and Comparative Examples 1 to 6 was prepared according to a component content ratio shown in Table 1.

The components listed in Table 1 were mixed in a common mixer and then, extruded into a thermoplastic resin composition in the form of pellets by using a twin-screw extruder (L/D=29, φ=45 mm) at a barrel temperature of about 240° C. Each of the thermoplastic resin composition pellets was dried in a dehumidifying dryer at about 80° C. for about 4 hours and then, injection-molded by a 6 oz injection molding machine set at a cylinder temperature of 240° C. and a mold temperature of 60° C. to prepare specimens for measuring properties. The measured properties are shown in Table 2.

In Table 1, the components (A) and (B) were expressed by wt % based on a total weight of the components (A) and (B), and the components (C) and (D) were expressed by parts by weight based on 100 parts by weight of a base resin including the components (A) and (B).

TABLE 1

| | Examples | | | Comparative Examples | | | | | |
|---|---|---|---|---|---|---|---|---|---|
| | 1 | 2 | 3 | 1 | 2 | 3 | 4 | 5 | 6 |
| (A-1) | 20 | — | — | — | — | — | — | — | 20 |
| (A-2) | — | 20 | — | 20 | 20 | 30 | — | 20 | — |
| (A-3) | — | — | 20 | — | — | — | — | — | — |
| (A-4) | — | — | — | — | — | — | 20 | — | — |
| (B-1) | 80 | 80 | 80 | — | — | 70 | 80 | 80 | 80 |
| (B-2) | — | — | — | 80 | — | — | — | — | — |
| (B-3) | — | — | — | — | 80 | — | — | — | — |
| (C-1) | 0.3 | 0.3 | 0.3 | 0.3 | 0.3 | 0.3 | 0.3 | — | 0.3 |
| (C-2) | — | — | — | — | — | — | — | 0.3 | — |
| (D-1) | 0.3 | 0.3 | 0.3 | 0.3 | 0.3 | 0.3 | 0.3 | 0.3 | — |
| (D-2) | — | — | — | — | — | — | — | — | 0.3 |

Each component in Table 1 is described as follows.

### (A-1) Acrylate-Based Rubber-Modified Graft Copolymer

A core-shell structure graft copolymer including about 50 wt % of a core including a butyl acrylate-styrene crosslinked copolymer having an average particle diameter of about 130 nm and a shell formed by grafting a styrene-acrylonitrile copolymer (SAN) having a weight ratio of a styrene-derived component and an acrylonitrile-derived component in a weight ratio of about 7:3 into the core (Manufacturer: Lotte Chemical Corp.) was used.

### (A-2) Acrylate-Based Rubber-Modified Graft Copolymer

A core-shell structure graft copolymer including about 60 wt % of a core including a butyl acrylate-styrene crosslinked copolymer with an average particle diameter of about 210 nm and a shell formed by grafting polymethyl methacrylate (PMMA) into the core (Manufacturer: Kaneka Corp., Product name: M-210) was used.

### (A-3) Acrylate-Based Rubber-Modified Graft Copolymer

A core-shell structure graft copolymer including about 60 wt % of a core including a butyl acrylate-silicone crosslinked copolymer with an average particle diameter of about 100 nm and a shell formed by grafting a styrene-acrylonitrile copolymer (SAN) of a styrene-derived component and an acrylonitrile-derived component in a weight ratio of about 2:1 into the core (Manufacturer: Mitsubishi Chemical Corp., Product name: SX006) was used.

### (A-4) Acrylate-Based Rubber-Modified Graft Copolymer

A core-shell structure graft copolymer including about 50 wt % of a core including a butyl acrylate-styrene cross-linking copolymer having an average particle diameter of about 350 nm and a shell formed by grafting a styrene-acrylonitrile copolymer (SAN) of a styrene-derived component and an acrylonitrile-derived component in a weight ratio of about 2:1 into the core (Manufacturer: Lotte Chemical Corp.) was used.

### (B-1) Polymethyl Methacrylate Resin

A polymethyl methacrylate resin having a weight average molecular weight of about 100,000 g/mol and a methyl acrylate-derived component content of about 2 wt % (Manufacturer: Lotte MCC Corp.) was used.

### (B-2) Polymethyl Methacrylate Resin

A polymethyl methacrylate resin having a weight average molecular weight of about 60,000 g/mol and a methyl acrylate-derived component content of about 5 wt % (Manufacturer: Asahi Kasei Corp.) was used.

### (B-3) Polymethyl Methacrylate Resin

A polymethyl methacrylate resin having a weight average molecular weight of about 90,000 g/mol and a methyl acrylate-derived component content of about 13% (Manufacturer: Trinseo) was used.

### (C-1) Anthraquinone-Based Dye

A dye containing 50 wt % or more of a component having a structure represented by Chemical Formula 2 (Manufacturer: Solusys Corp.) was used.

### (C-2) Carbon Black

Hiblack® 50L from Orion Engineered Carbons was used.

### (D-1) Multifunctional Radical Scavenger

A multifunctional radical scavenger having a structure represented by Chemical Formula 1 (Manufacturer: BASF, Product name: Irganox® 1010) was used.

### (D-2) Phenol-Based Radical Scavenger

A mono-functional radical scavenger with a hindered phenol type (Manufacturer: BASF, Product name: Irganox® 1076) was used.

### Property Evaluation

Specimens for measuring properties according to Examples 1 to 3 and Comparative Examples 1 to 6 were measured with respect to colorability, heat resistance, weather resistance, and appearance characteristics in the following methods, and the results are shown in Table 2.

Colorability: The specimens with a thickness of 2.5 mm were measured with respect to brightness (L*) according to ASTM E308 in a specular component excluded (SCE) mode by using CM-3700d made by Konica Minolta Inc. The lower brightness, the better black color, which confirmed more excellent colorability.

Heat resistance (unit: ° C.): A Vicat softening temperature (VST) was measured under B50 condition according to ISO 306 standard.

Weather resistance: The specimens were irradiated with energy of 4,500 kJ according to SAE J 1960 by using Ci4000 made by Atlas Material Testing Solutions and a color change (ΔE) of the specimens before and after the evaluation was measured with reference to the gloss surface in a specular component excluded (SCE) mode by using CM-3700d made by Konica Minolta, Inc.

Scratch resistance (unit: grade): Pencil hardness was measured according to JIS K5401 by placing a weight of 500 g on a pencil (9B to 9H) and then, 5 times pushing the pencil at 10 mm/s on the flat specimens to check when no scratches were generated.

Appearance characteristics (unit: ppm): After measuring a weight (mg unit) of an upper glass plate of a glass petri dish with a diameter of 5 cm, 4 g of a pellet-shaped molded product was placed on the glass petri dish to measure a weight (mg unit) and then, covered with the upper glass plate, heated at 250° C. on a hot plate for 2 hours, and cooled to room temperature to measure a weight increase of the upper glass plate, which was obtained as a volatile gas generation amount deposited on the upper glass plate. The smaller volatile gas generation amount, the less gas component deposited on the molded product, which confirmed excellent appearance characteristics.

TABLE 2

| | Examples | | | Comparative Examples | | | | | |
|---|---|---|---|---|---|---|---|---|---|
| | 1 | 2 | 3 | 1 | 2 | 3 | 4 | 5 | 6 |
| Brightness (L*) | 0.9 | 0.4 | 0.7 | 0.4 | 0.4 | 0.8 | 3.3 | 2.1 | 1.0 |
| VST | 101 | 101 | 101 | 97 | 93 | 97 | 100 | 101 | 100 |
| Color change (ΔE) | 1.0 | 0.7 | 0.8 | 0.6 | 0.6 | 1.1 | 0.8 | 1.8 | 1.0 |
| Pencil hardness | H grade | H grade | H grade | H grade | H grade | F grade | H grade | H grade | H grade |
| Volatile gas | 450 | 500 | 560 | 350 | 300 | 700 | 800 | 500 | 1,500 |
| generation amount | | | | | | | | | |

Referring to the results of Tables 1 to 2, the thermoplastic resin compositions including the components (A) to (D) and the molded products using the same were confirmed to exhibit excellent colorability, heat resistance, weather resistance, and appearance characteristics.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. A thermoplastic resin composition, comprising
based on 100 parts by weight of a base resin including
(A) 15 to 25 wt % of an acrylate-based rubber-modified graft copolymer; and
(B) 75 to 85 wt % of a polymethyl methacrylate resin including 0.5 to 3 wt % of a methyl acrylate-derived component,
(C) 0.1 to 1 part by weight of an anthraquinone-based dye; and
(D) 0.1 to 0.5 parts by weight of a multifunctional radical scavenger.

2. The thermoplastic resin composition of claim 1, wherein
the (A) acrylate-based rubber-modified graft copolymer includes a core including an acrylate-based rubbery polymer and a shell formed by graft polymerization of at least one selected from a (meth)acrylate-based compound, an aromatic vinyl compound, and a vinyl cyanide compound onto the core.

3. The thermoplastic resin composition of claim 2, wherein
an average particle diameter of the acrylate-based rubbery polymer is 100 to 250 nm.

4. The thermoplastic resin composition of claim 1, wherein
the (A) acrylate-based rubber-modified graft copolymer includes a butyl acrylate-styrene crosslinked copolymer core and a shell formed by grafting a styrene-acrylonitrile copolymer onto the core.

5. The thermoplastic resin composition of claim 1, wherein
the (A) acrylate-based rubber-modified graft copolymer includes a butyl acrylate-silicone crosslinked copolymer core and a shell formed by grafting a styrene-acrylonitrile copolymer onto the core.

6. The thermoplastic resin composition of claim 1, wherein
the (A) acrylate-based rubber-modified graft copolymer includes a butyl acrylate-styrene crosslinked copolymer core and a shell formed by grafting polymethyl methacrylate onto the core.

7. The thermoplastic resin composition of claim 1, wherein
the (B) polymethyl methacrylate resin including 0.5 to 3 wt % of the methyl acrylate-derived component includes 1 to 2 wt % of the methyl acrylate-derived component.

8. The thermoplastic resin composition of claim 1, wherein
the (D) multifunctional radical scavenger includes a structure represented by Chemical Formula 1: 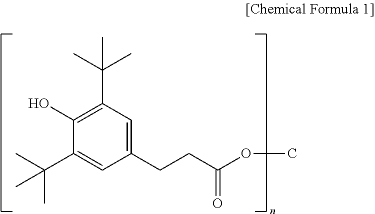
wherein in Chemical Formula 1, n is an integer of 2 to 4.

9. The thermoplastic resin composition of claim 1, wherein
the thermoplastic resin composition further includes at least one additive selected from a flame retardant, a nucleating agent, a coupling agent, a filler, a plasticizer, an impact modifier, a lubricant, a release agent, a heat stabilizer, an antioxidant, an ultraviolet stabilizer, a pigment, and a dye.

10. A molded product manufactured from the thermoplastic resin composition of claim 1.

11. The molded product of claim 10, wherein
the molded product has a brightness (L*) of less than or equal to 1.0, as measured in specular component excluded mode according to ASTM E308 on a 2.5 mm-thick specimen.

12. The molded product of claim 10, wherein
the molded product has a Vicat softening temperature (VST) of greater than or equal to 100° C. as measured under B50 conditions according to ISO 306 standard.

13. The molded product of claim 10, wherein
the molded product has a color change (ΔE) of less than or equal to 2.0 before and after a weathering test measured by irradiating the molded product with 4,500 kJ of energy according to the SAE J 1960 standard.

14. The molded product of claim 10, wherein
the molded product has a volatile gas generation amount of less than or equal to 600 ppm, as measured through a weight increase of the glass plate by placing 4 g of the molded product in a glass petri dish with a diameter of 5 cm, covering the top with a glass plate, heating it on a hot plate at 250° C. for 2 hours, and then cooling the plate temperature to room temperature.
